(19) United States
(12) Patent Application Publication
(10) Pub. No.: US 2020/0138046 A1
(43) Pub. Date: May 7, 2020

(54) STUFFED FOOD PROCESSING DEVICE

(71) Applicant: Qingyi JIA, Beijing (CN)

(72) Inventor: Qingyi JIA, Beijing (CN)

(21) Appl. No.: 16/734,305

(22) Filed: Jan. 4, 2020

Related U.S. Application Data
(63) Continuation of application No. PCT/CN2018/081738, filed on Apr. 3, 2018.

(30) Foreign Application Priority Data
Jul. 11, 2017 (CN) 201710558922.8

(51) Int. Cl. A21C 9/06; A23L 7/109

(52) U.S. Cl. CPC A21C 9/061; A23V 2002/00; A23L 7/11

(57) ABSTRACT

A device for processing food with stuffing, including a casing, an inclined auger, a vertical auger, a first pressing edge and a second pressing edge. This invention provides three mechanisms, including an extrusion forming mechanism, a feeding mechanism and a pressing-breaking mechanism. The casing and the inclined auger together form the extrusion forming mechanism which produces a continuous tubular wrapper through a gap. An inner cavity of the inclined auger and the vertical auger together form the feeding mechanism which fills the stuffing into the wrapper. The first pressing edge and the second pressing edge together form the pressing-breaking mechanism which is configured to seal and break food edges. The extrusion forming mechanism and the feeding mechanism can be integrated due to a suitable conical structure. The casing, as well as an external profile and an inner cavity of the inclined auger have an inverted cone shape.

### CROSS-REFERENCE TO RELATED APPLICATIONS

This application is a continuation of International Patent Application No. PCT/CN2018/081738, filed on Apr. 3, 2018, which claims the benefit of priority from Chinese Application No. 201710558922.8, filed on Jul. 11, 2017. The content of the aforementioned applications, including any intervening amendments thereto, are incorporated herein by reference.

### TECHNICAL FIELD

The application relates to food processing, and more particularly to a device for processing food with stuffing.

### BACKGROUND OF THE INVENTION

Commercially-available dumpling making machines have complex components and large size, which are not suitable for home use. A dumpling making machine for home use may appear if dumplings prepared by the machines are no longer required to have the shape of handmade dumplings.

In order to overcome the shortcomings of the commercially-available dumpling making machines, the invention provides a simplified and compact dumpling making machine, in which a dumpling wrapper making device and a stuffing-bearing device are separated.

### SUMMARY OF THE INVENTION

The invention aims to provide a device for processing food with stuffing, which can prepare dumplings having appearances that are slightly different from handmade dumplings. This invention fully utilizes rotational motion of mechanical components which is easily realized, and integrates an extrusion forming mechanism with a feeding mechanism, resulting in a simplified and compact dumpling making machine.

The technical solution of the invention is described as follows.

A device for processing food with stuffing includes a casing, an inclined auger, a vertical auger, a first pressing edge and a second pressing edge.

The casing is hollow and has an inverted cone shape. An upper end of the casing is open, and a lower end of the casing has radial shrinkage to form an annulus. The annulus protrudes downward and is located at a middle of the radial shrinkage. Two link-shafts are horizontally provided on an outer surface of the casing. Axes of the two link-shafts are coincident and perpendicularly intersect with a center axis of the casing.

The inclined auger is hollow and has an inverted cone shape. An upper end of the inclined auger is open. A conicity of an external profile of the inclined auger is adapted to a conicity of the casing. A vertical cylindrical tube is connected to a distal (lower) end of the inclined auger. An inner cavity of the inclined auger is a stuffing-bearing space.

The first pressing edge and the second pressing edge are linked to the two link-shafts on the casing.

The device for processing the food with stuffing provided herein is assembled through making axes of the casing, the inclined auger and the vertical auger coincide, and aligning bottom ends of the casing, the inclined auger and the vertical auger, and installing the first pressing edge and the second pressing edge on the two link-shafts.

The invention provides three functional mechanisms, including: an extrusion forming mechanism, a feeding mechanism and a pressing-breaking mechanism.

The casing and the inclined auger together form the extrusion forming mechanism, where an inner diameter of the annulus is larger than an outer diameter of the vertical cylindrical tube, thereby creating a gap. The gap is configured to form a wrapper of the food with stuffing. A thickness of the wrapper relies on a size of the gap. A space between the casing and the inclined auger is a squeezing space configured to squeeze dough. The dough is placed in the squeezing space. When the casing is fixed and the inclined auger rotates, the dough is forced downward and squeezed out from the gap, thereby forming the wrapper that is continuous, cylindrical and hollow.

The inner cavity of the inclined auger and the vertical auger together form the feeding mechanism, where the inner cavity of the inclined auger is the stuffing-bearing space, and the stuffing is placed in the stuffing bearing space. When the stuffing is required to fill the wrapper, the vertical auger rotates to force the stuffing downward through the vertical cylindrical tube. The amount of the stuffing wrapped into the wrapper relies on a rotation angle of the vertical auger rotates.

The first pressing edge and the second pressing edge together form the pressing-breaking mechanism, where the first pressing edge and the second pressing edge rotate around the two link-shafts. A first pressing surface is provided on the first pressing edge, and a second pressing surface is provided on the second pressing edge. A first breaking edge is located at a middle of the first pressing surface, and a second breaking edge is located at a middle of the second pressing surface. The first breaking edge and the second breaking edge are parallel and staggered. In order to ensure that breaking and pressing do not disturb each other, heights of the first and second breaking edges should be half of an edge thickness of the food. When two ends of a section of the wrapper are required to be pressed and sealed, the first and second pressing edges simultaneously press the wrapper, so that an upper edge of the food, i.e., a lower edge of next food is pressed and broken.

The inclined auger has two functions. Firstly, an outer surface of the inclined auger facilitates the forming of the wrapper, and the inner cavity of the inclined auger is a container of stuffing.

The device for processing the food with stuffing provided in the invention has simplified mechanisms and a small size, which is suitable for home use.

### BRIEF DESCRIPTION OF THE DRAWINGS

FIG. 1 is a cross-sectional view of a casing, where axes of the casing and two link-shafts are in a cutting plane of the casing.

FIG. 2 is a cross-sectional view of an inclined auger, where an axis of the inclined auger is a cutting plane of the inclined auger.

FIG. 3 is an axial side view of a first pressing edge.

FIG. 4 is a front view of a vertical auger.

FIG. 5 is an axial side view of a second pressing edge.

FIG. 6 is a cross-sectional view showing how the first and second pressing edges press food edges, where axes of the casing and the inclined auger are in a cutting plane of the first and second pressing edges, and axes of the two link-shafts is perpendicular to the cutting plane of the first and second pressing edges.

FIG. 7 shows an external profile of food with stuffing processed in the invention.

FIG. 8 is an axial side view of a processing device provided in the invention, where a cross-sectional view of the casing and the inclined auger is shown herein, and the axes of the casing and the inclined auger are in a cutting plane of the casing and the inclined auger, and the axes of the two link-shafts are perpendicular to the cutting plane of the casing and the inclined auger passes.

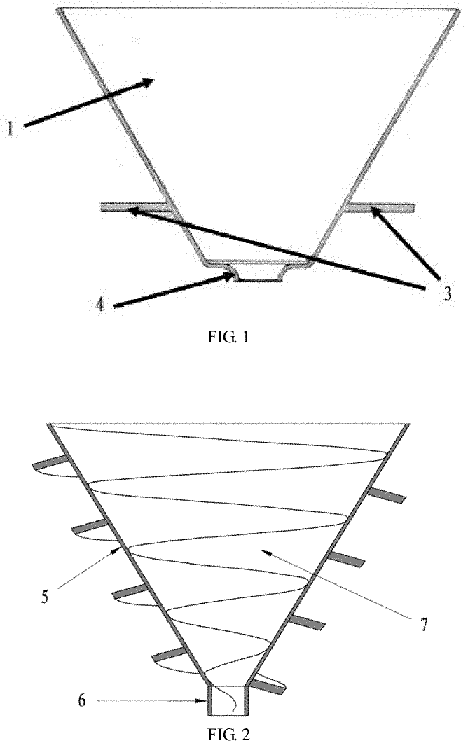

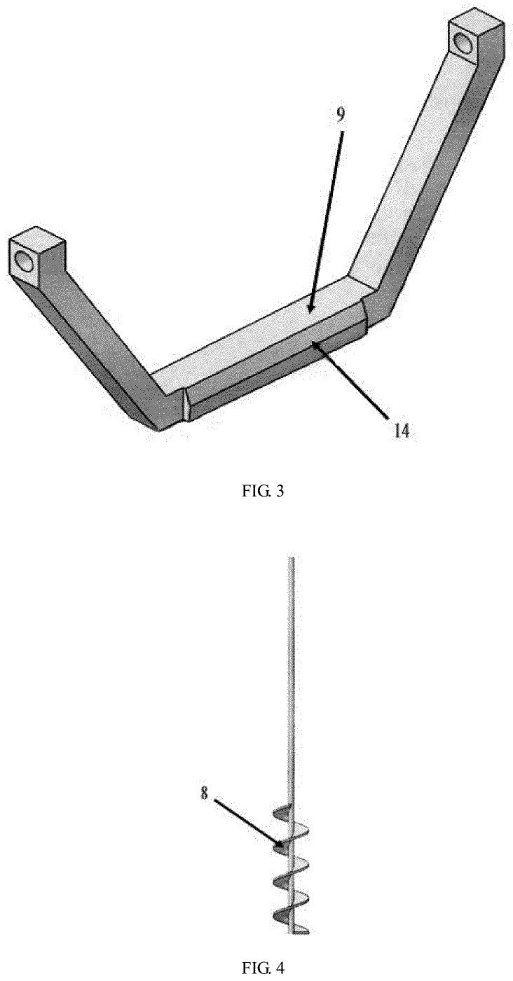

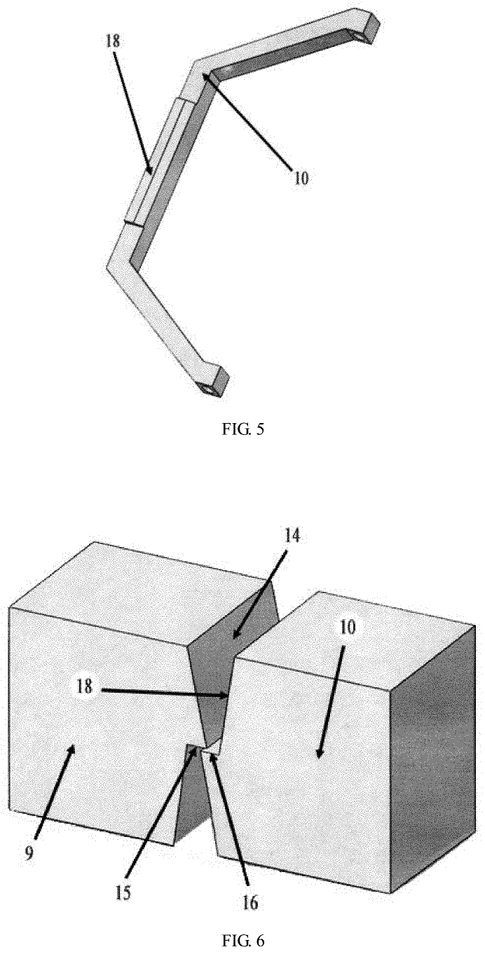

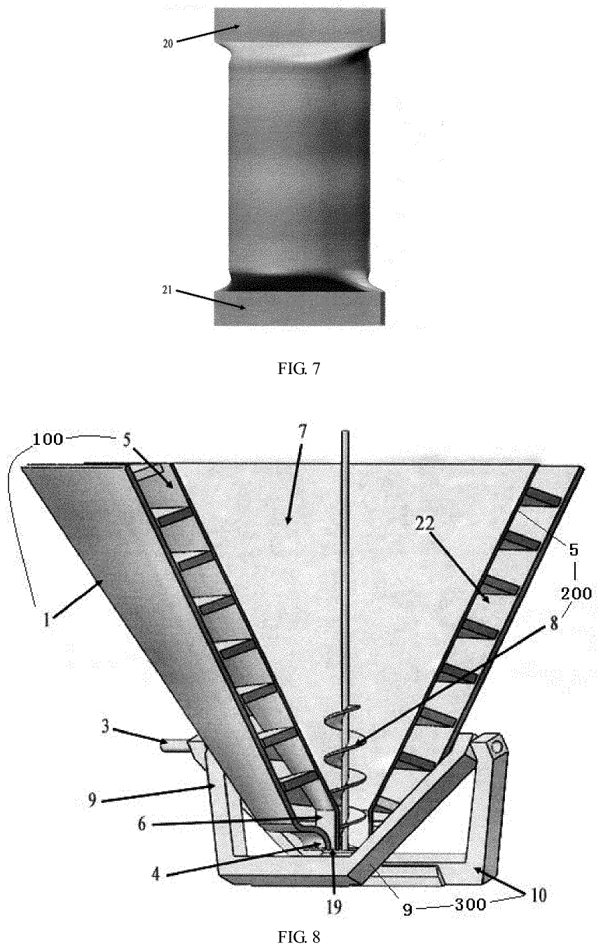

### DETAILED DESCRIPTION OF EMBODIMENTS

The technical solution of the invention is described as follows.

A device for processing food with stuffing includes a casing 1, an inclined auger 5, a vertical auger 8, a first pressing edge 9 and a second pressing edge 10.

The casing 1 is hollow and has an inverted cone shape. An upper end of the casing 1 is open, and a lower end of the casing 1 has radial shrinkage to form an annulus 4. The annulus 4 protrudes downward and is located at a middle of the radial shrinkage. Two link-shafts 3 are horizontally provided on an outer surface of the casing 1. Axes of the two link-shafts are coincident and perpendicularly intersect with a center axis of the casing 1.

The inclined auger 5 is hollow and has an inverted cone shape. An upper end of the inclined auger 5 is open. A conicity of an external profile of the inclined auger is adapted to a conicity of the casing 1. A vertical cylindrical tube 6 is connected to a distal (lower) end of the inclined auger. An inner cavity of the inclined auger 5 is a stuffing-bearing space 7.

The first pressing edge 9 and the second pressing edge 10 are linked to the two link-shafts 3 on the casing 1.

The device for processing the food with stuffing provided herein is assembled through making axes of the casing 1, the inclined auger 5 and the vertical auger 8 coincide, and aligning bottom ends of the casing 1, the inclined auger 5 and the vertical auger 8, and installing the first pressing edge 9 and the second pressing edge 10 on the two link-shafts 3.

The invention provides three functional mechanisms, including: an extrusion forming mechanism 100, a feeding mechanism 200 and a pressing-breaking mechanism 300.

The casing 1 and the inclined auger 5 together form the extrusion forming mechanism 100, where an inner diameter of the annulus 4 is larger than an outer diameter of the vertical cylindrical tube 6, thereby creating a gap 19. The gap 19 is configured to form a wrapper of the food with stuffing. A thickness of the wrapper relies on a size of the gap 19. A space between the casing 1 and the inclined auger 5 is a squeezing space 22 configured to squeeze dough. The dough is placed in the squeezing space 22. When the casing 1 is fixed and the inclined auger 5 rotates, the dough is forced downward and squeezed out from the gap 19, thereby forming the wrapper that is continuous, cylindrical and hollow.

The inner cavity of the inclined auger 5 and the vertical auger 8 together form the feeding mechanism 200, where the inner cavity of the inclined auger 5 is the stuffing-bearing space 7, and the stuffing is placed in the stuffing bearing space 7. When the stuffing is required to fill the wrapper, the vertical auger 8 rotates to force the stuffing downward through the vertical cylindrical tube 6. The amount of the stuffing wrapped into the wrapper relies on a rotation angle of the vertical auger 8 rotates.

The first pressing edge 9 and the second pressing edge 10 together form the pressing-breaking mechanism 300, where the first pressing edge 9 and the second pressing edge 10 rotate around the two link-shafts 3. A first pressing surface 14 is provided on the first pressing edge 9, and a second pressing surface 18 is provided on the second pressing edge 10. A first breaking edge 15 is located at a middle of the first pressing surface 14, and a second breaking edge 16 is located at a middle of the second pressing surface 18. The first breaking edge 15 and the second breaking edge 16 are parallel and staggered. In order to ensure that breaking and pressing do not disturb each other, heights of the first and second breaking edges should be half of an edge thickness of the food. When two ends of a section of the wrapper are required to be pressed and sealed, the first and second pressing edges simultaneously press the wrapper, so that an upper edge of the food, i.e., a lower edge of next food is pressed and broken.

The inclined auger 5 has two functions. Firstly, an outer surface of the inclined auger facilitates the forming of the wrapper, and the inner cavity of the inclined auger is a container of stuffing.

The procedures of making the food with stuffing are described as follows. The first pressing edge 9 and the second pressing edge 10 simultaneously press and break the wrapper without filling the stuffing for sealing a lower edge 21 of the food. The inclined auger 5 rotates to form a wrapper with a required length, and the stuffing fills the wrapper, and then the first pressing edge 9 and the second pressing edge 10 simultaneously press and break the wrapper to seal an upper edge 20 of the food. A sequence of steps of filling and breaking is continuously performed to prepare the food with stuffing one by one.

What is claimed is:

1. A device for processing food with stuffing, comprising:
a casing;
an inclined auger;
a vertical auger;
a first pressing edge; and
a second pressing edge;
wherein the casing and the inclined auger together form an extrusion forming mechanism; an inner cavity of the inclined auger and the vertical auger together form a feeding mechanism for feeding and loading the stuffing; the first pressing edge and the second pressing edge together form a pressing-breaking mechanism; and the feeding mechanism is embedded in the extrusion forming mechanism.

2. The device of claim 1, wherein the inclined auger is hollow.

3. The device of claim 1, wherein an inner space of the inclined auger has an inverted cone shape.

4. The device of claim 1, wherein the casing has an inverted cone shape.

5. The device of claim 1, wherein an external profile of the inclined auger has an inverted cone shape.

6. Food prepared by the device for processing food with stuffing, characterized in that the food contains the stuffing wrapped into the wrapper; and the food is sealed by pressing two ends of the wrapper that is tubular and has a desired length.

7. A method of preparing the food according to claim 6, comprising:
pressing and breaking, by the pressing-breaking mechanism, one end of the wrapper to seal one opening of the wrapper;
filling, by the feeding mechanism, the stuffing into the wrapper from the other opening of the wrapper; and
pressing and breaking, by the pressing-breaking mechanism, the other end of the wrapper filled with the stuffing to seal the other opening of the wrapper to produce the food.
